(19) United States
(12) Patent Application Publication
(10) Pub. No.: US 2015/0283746 A1
(43) Pub. Date: Oct. 8, 2015

(54) Air Spinning Machine and Method for the Operation of an Air Spinning Machine

(71) Applicant: Maschinenfabrik Rieter AG, Winterthur (CH)

(72) Inventors: Gernot Schäffler, Waschenbeuren (DE); Andreas Fischer, Steckborn (CH); Javier-Orlando Ricaurte-Rubio, Gingen (Fils) (DE); Markus Arbogast, Heidenheim (DE)

(21) Appl. No.: 14/677,151

(22) Filed: Apr. 2, 2015

(30) Foreign Application Priority Data
Apr. 3, 2014 (CH) 00521/14

(51) Int. Cl. B29C 47/00

(52) U.S. Cl. CPC B29C 47/0014; B29L 2031/707

(57) ABSTRACT

The invention relates to an air spinning machine with at least one spinning unit (15) comprising at least one spinning nozzle (1), whereas the spinning unit (15) serves the purpose of producing a yarn (2) from a fiber composite (3) fed from a spinning nozzle (1), whereas the spinning nozzle (1) features an inlet (4) for the fiber composite (3), an internal vortex chamber (5), a yarn formation element (6) protruding into the vortex chamber (5), along with an outlet (7) for the yarn (2) produced inside the vortex chamber (5), and whereas the spinning nozzle (1) features multiple air nozzles (23) leading into the vortex chamber (5), which are in fluid connection with at least one air supply line (24), whereas, during the operation of the air spinning machine, compressed air provided by the air supply line (24) flows through the air nozzles (23) into the vortex chamber (5) in order to generate a vortex air flow in the vortex chamber (5). In accordance with the invention, it is proposed that the air spinning machine features an additive supply (8), which is formed to provide the spinning unit (15) with an additive (9), whereas the additive supply (8) comprises a pressure tank (11) in which the additive (9) is held for forwarding to the area of the spinning unit (15) and in which a gaseous pressure medium (12) is contained, and whereas the additive supply (8) comprises at least one additive supply line (14) running independent of the specified air supply line (24), through which the pressure tank (11) is connected to an additive delivery (13), and through which the additive (9) of the spinning nozzle (1) is able to be fed independent of the compressed air introduced through the air supply line (24) into the vortex chamber (5). In addition, a method for operating an air spinning machine is proposed.

This invention relates to an air spinning machine with at least one spinning unit comprising at least one spinning nozzle, whereas the spinning unit serves the purpose of producing a yarn from a fiber composite fed from a spinning nozzle, whereas the spinning nozzle features an inlet for the fiber composite, an internal vortex chamber, a yarn formation element protruding into the vortex chamber, and an outlet for the yarn produced inside the vortex chamber, and whereas the spinning nozzle features multiple air nozzles leading into the vortex chamber, which are in fluid connection with at least one air supply line, whereas, during the operation of the air spinning machine, compressed air provided by the air supply line flows through the air nozzles into the vortex chamber in order to generate a vortex air flow in the vortex chamber.

Furthermore, a method for the operation of the air spinning machine is proposed, whereas the air spinning machine features at least one spinning unit, whereas the spinning unit features at least one spinning nozzle, whereas, during the operation of the spinning unit, the spinning nozzle feeds a fiber composite through an inlet, and whereas the spinning nozzle features multiple air nozzles leading into the vortex chamber, which are in fluid connection with at least one air supply line, whereas, during the operation of the air spinning machine, compressed air provided by the air supply line flows through the air nozzles into the vortex chamber in order to generate a vortex air flow within the vortex chamber, whereas the fiber composite within a vortex chamber of the spinning nozzle receives a twist with the assistance of the vortex air flow, such that a yarn is formed from the fiber composite, which ultimately leaves the spinning unit through an outlet.

Air spinning machines with corresponding spinning units are known in the state of the art, and serve the purpose of producing a yarn from an elongated fiber composite. Thereby, the outer fibers of the fiber composite are, with the assistance of a vortex air flow generated by the air nozzles within the vortex chamber in the area of the inlet mouth of the yarn formation element, wound around the internal core fibers, and ultimately form the winding fibers that determine the desired strength of the yarn. This creates a yarn with a genuine twist, which may be ultimately led away through a draw-off channel from the vortex chamber, and wound up, for example, on a sleeve.

In general, within the meaning of the invention, the term “yarn” is understood to be a fiber composite, for which at least one part of the fibers is wound around an internal core. Thus, this comprises a yarn in the conventional sense, which may be processed into a fabric, for example with the assistance of a weaving machine. However, the invention also relates to air spinning machines, with the assistance of which so-called “roving” (another name: coarse roving) may be produced. This type of yarn is characterized by the fact that, despite a certain strength, which is sufficient to transport the yarn to a subsequent textile machine, it is still capable of drafting. Thus, the roving may be drafted with the assistance of a drafting device, for example the stretching unit, of a textile machine processing the roving, for example a ring spinning machine, before it is ultimately spun.

In the production of synthetic fibers, such as polyester, or mixtures of natural and synthetic fibers, deposits on the surface of the yarn formation element arise. The production of synthetic fibers comprises a so-called “preparation of continuous fibers” during the production process. Preparation agents, usually oils with various additives, are applied at the continuous fibers; this enables a treatment such as, for example, stretching the continuous fibers at high speeds. Such preparation agents sometimes adhere to the synthetic fibers even during the further treatment, and lead to impurities in the air spinning machine. The fibers fed to the air spinning machine in the form of a fiber composite are typically fed by a pair of delivery rollers of the spinning nozzle. The pair of the delivery rollers may match a pair of output rollers of a stretching unit. The stretching unit that is used serves the purpose of the refinement of the advanced fiber composite prior to entering the spinning nozzle.

Typically, a fiber guide element is arranged in the entrance area of the spinning nozzle; through this, the fiber composite is led into the spinning nozzle and finally into the area of the yarn formation element. As yarn formation elements, the majority of spindles are used with an internal draw-off channel. At the top of the yarn formation element, compressed air is introduced through the housing wall of the spinning nozzle in such a manner that the specified rotating vortex air flow arises. As a result, individual external fibers are separated from the fiber composite leaving the fiber guide element and are turned over through the top of the yarn formation element. In the further process, these removed fibers rotate on the surface of the yarn formation element. Following this, through the forward movement of the internal core fibers of the fiber composite, the rotating fibers are wound around the core fibers and thereby form the yarn. However, through the movement of the individual fibers over the surface of the yarn formation element, deposits also form on the yarn formation element because of adhesions on the fibers from the production process. For the same reasons, deposits may also occur on the surface of the interior of the spinning nozzle or the fiber guide element. These adhesions lead to a deterioration of the surface condition of the yarn formation element, and cause a deterioration in the quality of produced yarn. Therefore, the regular cleaning of the affected surfaces is necessary in order to maintain the consistent quality of the spun yarns.

The surfaces of the yarn formation element, the interior of the spinning nozzle and the fiber guide element may be cleaned manually through a periodic disassembly of the yarn formation element, but this leads to a substantial maintenance effort, coupled with a corresponding interruption in operations.

By contrast, EP 2 450 478 discloses a device that enables an automatic cleaning without stopping the machine. For this purpose, an additive is mixed with the compressed air used for the formation of vortex air flow within the spinning nozzle. The additive is guided through the compressed air on the yarn formation element, and results in the cleaning of the surface of the yarn formation element.

JP-2008-095-208 discloses an additional version of the cleaning of the yarn formation element. An additive is also fed to the compressed air used for the swirling in the spinning nozzle, and with such compressed air, is led into the spinning nozzle, and thus to the yarn formation element. In the disclosed version, the dosage and the addition of the additive is separately provided for each spinning unit.

In addition, feeding the additive to the fiber composite, in order to improve the properties of the yarn produced from it, with regard to (for example) its hairiness, strength, elongation and yarn uniformity, is known, whereas the dosage should be very precisely adjustable, in order to prevent more than or less than the indicated target additive quantity from being applied to the individual sections of the fiber composite.

Therefore, the task of this invention is to propose an air spinning machine along with a method for operating an air spinning machine, which enables the providing of an additive to one or more spinning units in a manner that is highly reliable and easy to adjust.

The task is solved by an air spinning machine and a method with the characteristics of the independent patent claims.

In accordance with the invention, the air spinning machine is characterized by the fact that it features an additive supply, which is formed to provide the spinning unit with an additive, whereas the additive supply comprises a pressure tank in which the additive is held for forwarding to the area of the spinning unit and in which a gaseous pressure medium is also contained. In addition, the additive supply comprises at least one additive supply line running independent of the specified air supply line, through which the pressure tank is connected to an additive delivery, and through which the additive of the spinning nozzle is able to be fed independent of the compressed air introduced through the air supply line into the vortex chamber. Thus, the air spinning machine comprises at least two independent supply systems, whereas one serves the purpose of the compressed air supply of the air nozzles and a second serves the purpose of the additive supply of the spinning nozzle(s). Thereby, it is possible to adjust the pressure prevailing in the pressure tank, which, with otherwise constant conditions, has direct effects on the volume flow or mass flow of the additive, regardless of the pressure of the compressed air necessary for yarn production that flows through the air nozzles into the vortex chamber.

Thereby, the pressure tank is partially filled with additive and partially filled with a gaseous pressure medium, preferably compressed air. Through the pressure acting on the additive from the pressure medium, this is ultimately conveyed through one or more additive supply lines in the area of the additive delivery(ies). There, it exits from the system of the additive supply, and arrives either in the interior of the spinning nozzle, or on the fiber composite coming into the spinning nozzle.

Fluid or even solid substances (or mixtures thereof) may be used as additive, whereas water or an aqueous solution (such as a cleaning solution) is preferential. The pressure tank can be formed by a closed and pressure-tight metal container, which is preferably fixed to a frame element or a support element of the air spinning machine.

In an additional form of the invention, it is advantageous if the additive delivery is arranged in the area of the spinning nozzle, whereas the additive delivery may be formed, for example, by a hollow needle, a spray head or an outlet area of a channel section. In particular, it is conceivable to place the additive delivery in the area of the inlet of the spinning nozzle, in particular in the area of the fiber guide element arranged therein, in order to apply the additive to the fiber composite before it enters the vortex chamber. Alliteratively, the additive delivery may also directly flow into the spinning nozzle or the vortex chamber, in order to deliver the additive into the interior of the spinning nozzle.

Furthermore, it is advantageous if the absolute pressure within the pressure tank features an amount that is between 1.1 and 8.0 bar, preferentially between 1.5 and 7.0 bar. While a low pressure is sufficient to deliver the additive at one location, which is only exposed to the surrounding air pressure of the spinning unit, a higher pressure may be sensible if the additive is to be delivered in an area that is already applied with an excess pressure, for example, at the inside of the vortex chamber. In addition or as an alternative, the pressure may be modified, depending on the operation of the air spinning machine. For example, it is conceivable to increase the pressure during a cleaning operation, during which the additive serves the purpose of cleaning the spinning nozzle, compared to the pressure that is selected during normal operation, with which the additive is primarily used to improve the properties of the finished yarn. In such a case, the pressure increase would lead to an increase in the additive delivery during the cleaning operation.

It is also advantageous if the air spinning machine includes several spinning units, whereas the additive deliveries of at least a part of the spinning units, preferably all spinning units, are in fluid connection with a common pressure tank through additive supply lines. For example, the air spinning machine could include two opposite rows of spinning units, whereas each row could be in connection with a common pressure tank. Alternatively, all spinning units may of course be in connection with only one pressure tank, such that the pressure tank would be centrally placed and easily refillable. In this connection, it is sensible to design the additive supply lines to be at least partially flexible, in order to enable a maintenance-related movement of the spinning nozzles or individual components of the same connected to the additive supply line.

It is also advantageous if the pressure tank is in connection with a main supply line, from which the additive supply lines of the individual spinning units branch off. In addition, the individual additive supply lines should include an adjustable valve, in order to adjust the mass flow or volume flow of the additive passing the corresponding additive supply lines (preferably, individually for each spinning unit), whereas, in addition or as an alternative, the pressure in the pressure tank can be varied, in order to quantitatively adjust the additive delivery in the area of the spinning nozzles.

It is likewise advantageous if the additive supply line(s) and/or the aforementioned main supply line include a manual valve that may be manually opened and closed. Thereby, the additive feed to all or selected spinning nozzles may be disabled quickly and reliably, without the pressure in the pressure tank having to be correspondingly reduced.

It is particularly advantageous if the pressure tank is in connection with a compressed air generator. The compressed air generator preferably comprises a compressor that sucks in surrounding air and brings it into the pressure tank in compressed form. As an alternative or in addition, it is likewise conceivable that the pressure tank is in connection with the compressed air supply of the air spinning machine, whereas this may comprise a compressed air supply network of the air spinning machine or a compressed air network of a spinning mill, to which the air spinning machine is also connected, whereas a throttle valve may in any event be upstream of the pressure tank, in order to adjust the pressure in the pressure tank.

It is advantageous if the pressure tank is in connection with an additive reservoir, whereas a sensor for monitoring the additive level of the pressure tank may be allocated to the pressure tank. The additive reservoir may comprise, for example, a container, which for its part is under pressure that is higher than the pressure inside the pressure tank. In such a case, additive automatically flows into the pressure tank, as soon as a corresponding valve, which may be arranged in a line connecting the pressure tank and the additive reservoir, is opened. Alternatively, the additive may also be conveyed into the pressure tank with a pump. Both the specified valve and the pump may be connected to a controller that opens the valve or activates the pump as soon as the sensor reports an additive level that is below a target value. Of course, the valve and/or the pump may also be operated manually, whereas the specified sensor may be designed to only indicate the additive level, without being connected to a controller.

It is also advantageous if the pressure tank and/or the additive reservoir and/or a line connecting the pressure tank and the additive reservoir features a valve, whereas the valve position automatically changes depending on the additive level of the pressure tank, such that the additive level always features a level between two thresholds. The valve may be in connection with, for example, a float gauge, which is arranged within the pressure tank and raises or lowers depending on the level of additive.

It may also be advantageous if the pressure tank and/or the additive reservoir and/or a line connecting the pressure tank and the additive reservoir, or even the corresponding main supply lines or the respective additive supply lines feature a filter for filtering the additive. Regardless of the exact position of the filter, it may be necessary to filter the additive, preferably prior to entering into the aforementioned valve, in order to prevent impurities in the valve, the additive delivery or the spinning nozzle. For example, it is conceivable to use a particulate filter and/or a lime filter. The filter is preferably attached in a detachable manner, in order to easily replace and clean it.

Furthermore, it is advantageous if the respective additive supply lines and/or the additive deliveries each feature a means for adjusting the volume flow and/or the mass flow of the additive delivered through the respective additive deliveries. The means may comprise, for example, a valve that is adjustable manually or with the assistance of a controller, in order to change the quantity of the additive passing the valve, whereas the valve in the aforementioned cleaning operation may have a different position than that in normal operation.

It would be likewise conceivable that the position of the individual valves upon the transition between normal operation and cleaning operation remains unchanged, and that the quantity of the additive delivered in the areas of the spinning nozzles is changed centrally by modifying the pressure in the pressure tank (relatively high pressure during cleaning operation compared to relatively low pressure during normal operation).

The method in accordance with the invention for the operation of an air spinning machine is characterized by the fact that the spinning unit(s) is/are, during the operation of the air spinning machine, at least partially fed an additive with the assistance of an additive supply. The additive supply includes, among other things, a pressure tank, preferably that is internal to the spinning machine, in which the additive is held for forwarding to the area of the spinning nozzle(s). Moreover, the pressure tank contains a gaseous pressure medium, preferably in the form of compressed air, whereas the pressure of the pressure medium is selected to be so high that, based on the pressure prevailing in the pressure tank, additive from the pressure tank is forwarded at least partially to one or more additive delivery(ies) of the spinning unit(s). The forwarding finally takes place with the assistance of additive supply lines running independent of the air supply line. With respect to the additive and the physical characteristics of the air spinning machine, reference is made to the prior and subsequent description, whereas the method may be used in connection with air spinning machines that feature one or more of the above characteristics.

It is advantageous if the additive is applied to the fiber composite with the assistance of the additive delivery and/or is introduced into the spinning nozzle. For example, it is conceivable that the additive is applied outside of the spinning nozzle or in the area of the fiber guide element and is introduced, together with this, into the vortex chamber of the spinning nozzle. Depending on the volume flow or mass flow, the additive serves the purpose of either improving the properties of the yarn produced from the fiber composite or cleaning the vortex chamber and/or the yarn formation element, whereas, in such a case, the fiber composite supports the cleaning by means of mechanical contact with the respective surfaces of the vortex chamber and/or the yarn formation element. Of course, the additive delivery may also flow directly into the vortex chamber, in order to introduce the additive into it, independent of the fiber composite.

It is also advantageous if the additive level of the pressure tank is monitored with the assistance of a sensor, whereas, upon falling below a threshold of the additive level, additive is delivered from an additive reservoir into the pressure tank, until a given additive level is reached. In such a case, the pressure tank always has a sufficient quantity of additive, in order to correspondingly supply the connected spinning units. The additive reservoir may comprise a pressurized cartridge or any other container, which, for example, may be connected to the pressure tank through a pump or is even under an increased pressure.

It is likewise advantageous if the air spinning machine includes several spinning units, whereas the additive streams, at least partially from the pressure tank, into one or more main supply lines and from there, through additive supply lines that branch off from the main supply line(s), to the respective additive deliveries of the spinning nozzles. In such a case, the additive is, for example, split off from a central pressure tank originating on several additive supply lines, and is fed to the respective spinning units or their spinning nozzles.

It is advantageous if the pressure tank is applied with an absolute pressure, the amount of which is between 1.1 bar and 8.0 bar, preferentially between 1.5 bar and 7.0 bar. The pressure may be selected depending on, among other things, whether the air spinning machine is operated in the aforementioned cleaning operation or the likewise aforementioned normal operation, whereas, in cleaning operation, a pressure of at least 3 bar is advisable, and the pressure during normal operation should be below this value.

Additional advantages of the invention are described in the following embodiments. The following is shown:

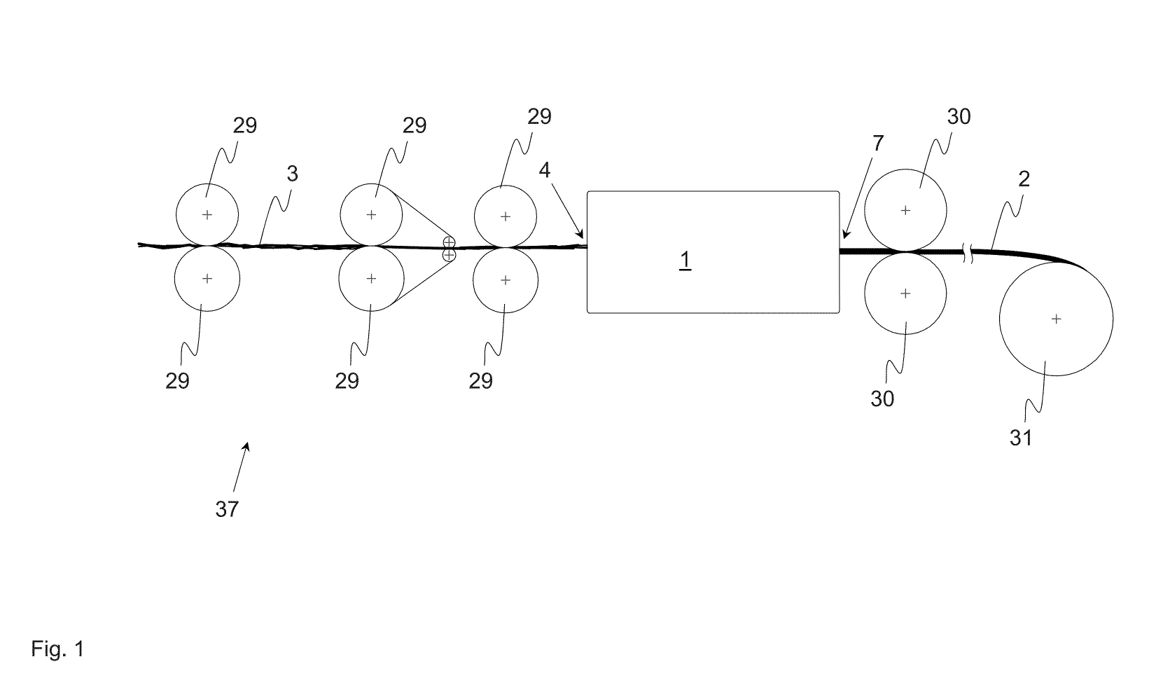

FIG. 1 a cut-out of the spinning unit of an air spinning machine,

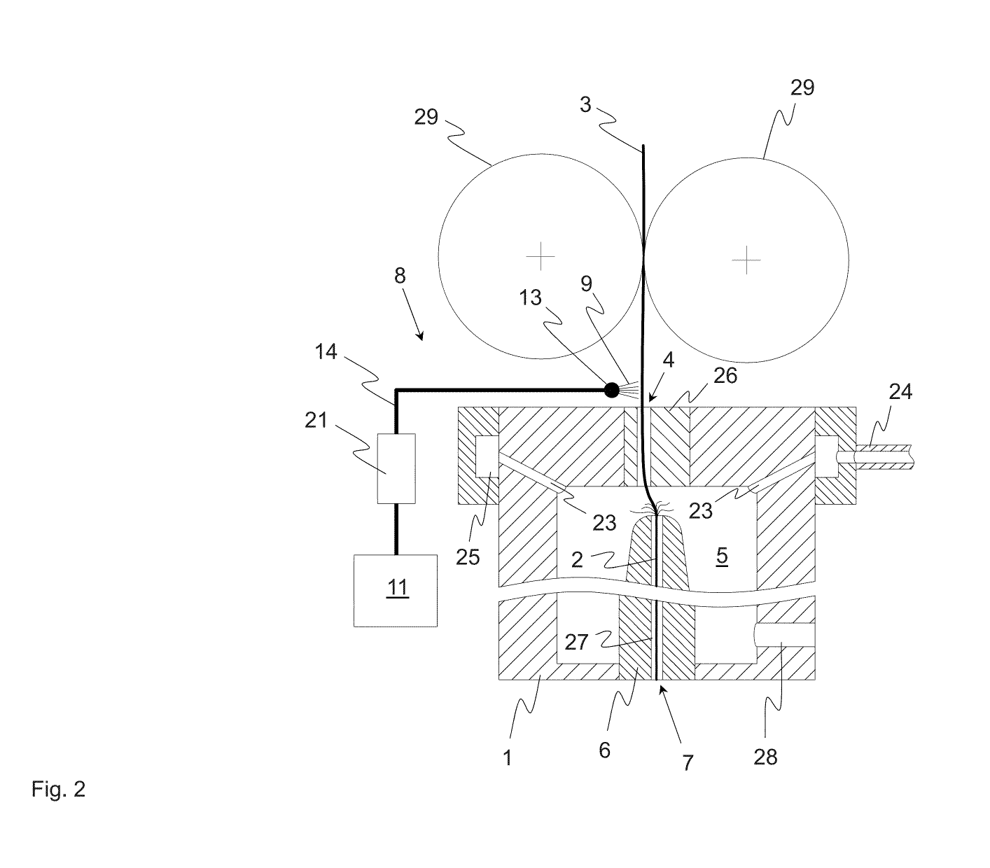

FIG. 2 a cut-out of a spinning unit of an air spinning machine in accordance with the invention,

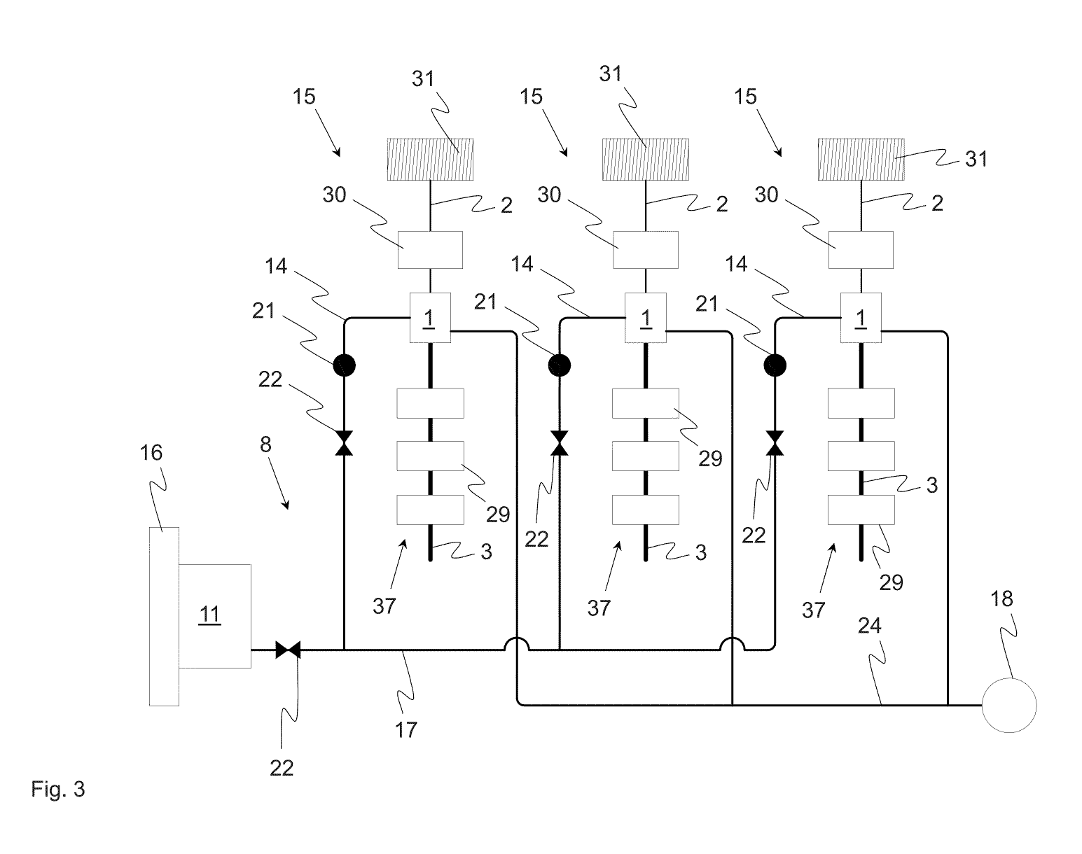

FIG. 3 a schematic sketch of a cut-out of an air spinning machine in accordance with the invention

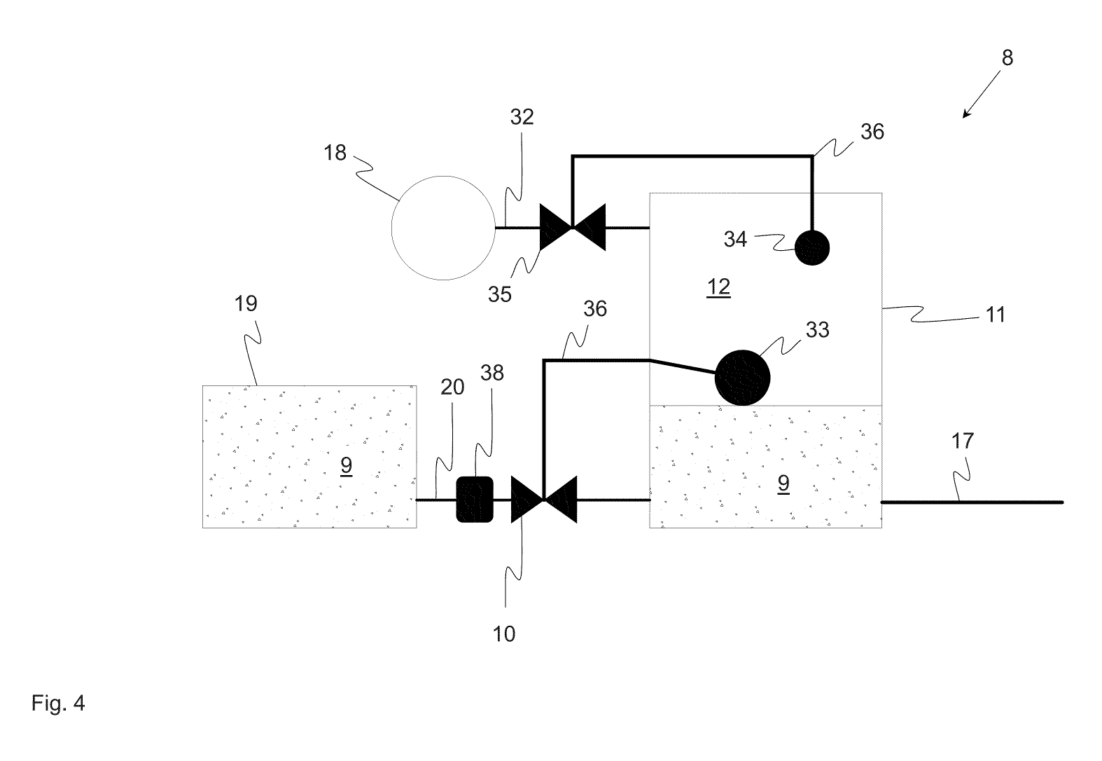

FIG. 4 a cut-out of an additive supply to be used in accordance with the invention.

FIG. 1 shows a cut-out of a spinning unit 15 of an air spinning machine in accordance with the invention (whereas the air spinning machine may, of course, feature a multitude of spinning units 15, preferably arranged in a manner adjacent to each other, as shown in FIG. 3). When required, the air spinning machine may include a stretching unit 37 with several stretching unit rollers 29, which is supplied with a fiber composite 3 in the form of, for example, a doubled stretching band. Furthermore, the spinning unit 15 that is shown includes a spinning nozzle 1 that is illustrated more specifically in FIG. 2 with an intemal vortex chamber 5, in which the fiber composite 3 or at least a part of the fibers of the fiber composite 3 is, after passing an inlet 4 of the spinning nozzle 1, provided with a twist (the exact mode of action of the spinning unit 15 is described in more detail below).

Moreover, the air spinning machine may include a pair of draw-off rollers that is subordinate to the spinning nozzle 1 and features two draw-off rollers 30, along with a spooling device 31 downstream of the pair of draw-off rollers for the spooling of the yarn 2 leaving the spinning unit 15 on a sleeve. The spinning unit 15 in accordance with the invention need not necessarily feature a stretching unit 37. The pair of draw-off rollers is also not absolutely necessary.

Generally, the spinning unit 15 that is shown works according to an air spinning process. For the formation of the yarn 2, the fiber composite 3 is led through a fiber guide element 26, which is provided with an inlet opening forming the specified inlet 4, into the vortex chamber 5 of the spinning nozzle 1. At that point, it receives a twist; that is, at least a part of the free fiber ends of the fiber composite 3 is captured by a vortex air flow that is generated by air nozzles 23 correspondingly arranged in a vortex chamber wall surrounding the vortex chamber 5. Thereby, a part of the fibers is pulled out of the fiber composite 3 at least to some extent, and wound around the top of the yarn formation element 6 protruding into the vortex chamber 5. Given that the fiber composite 3 is extracted through an inlet mouth of the yarn formation element 6 through a draw-off channel 27 arranged within the yarn formation element 6, out of the vortex chamber 5, and finally through an outlet 7 out of the spinning nozzle 1, the free fiber ends are also ultimately drawn in the direction of the inlet mouth and thereby, as so-called “winding fibers,” loop around the core fiber running in the center—resulting in a yarn 2 featuring the desired twist. The compressed air introduced through the air nozzles 23 leaves the spinning nozzle 1 ultimately through the draw-off channel 27 along with an air outlet 28 that might be present, which, when required, may be connected to a vacuum power source.

In general, it must be clarified at this point that the produced yarn 2 generally comprises any fiber composite 3, which is characterized by the fact that an external part of the fibers (so-called “winding fibers”) is looped around an internal part of the fibers that is preferably untwisted or, where required, twisted, in order to impart the desired strength to the yarn 2. The invention also comprises an air spinning machine, with the assistance of which so-called “roving” may be produced. The roving may comprise a yarn 2 with a relatively low proportion of winding fibers, or a yarn 2 for which the winding fibers are looped, relatively loosely, around the inner core, such that the yarn 2 remains capable of drafting. This is crucial if the produced yarn 2 should be or must be drafted on a subsequent textile machine (for example, a ring spinning machine), once again with the assistance of a stretching unit 37, in order to further process it accordingly.

With regard to the air nozzles 23, it must also be mentioned at this point, purely as a matter of precaution, that they typically should be generally aligned in such a manner that the escaping air streams are unidirectional, in order to generate a unidirectional air flow with a rotational direction. Preferably, the individual air nozzles 23 are thereby arranged in a manner that is rotationally symmetric to each other, and tangentially flow into the vortex chamber 5.

In accordance with the invention, the spinning unit 15 is allocated with an additive supply 8, which includes one or more pressure tanks 11 providing the additive 9 along with one or more additive supply lines 14, which are preferably at least partially flexible, through which the respective additive reservoir 19 is in fluid connection with an additive delivery 13 arranged in the area of or within the spinning nozzle 1 (with regard to possible additives 9, reference is made to the prior description).

In this connection, it must be noted that the additive 9 may be delivered at a varying location. While FIG. 2 shows an embodiment for which the additive delivery 13 is located in the area of the inlet 4 of the spinning nozzle 1, for example in the area of its fiber guide element 26 (such that the additive 9 may be applied directly on the fiber composite 3), the additive 9 may also be introduced through an air distributor 25 that, for example, runs in a ring form and is in connection with an air supply line 24. In such a case, the additive 9 arrives in the vortex chamber 5 through the air nozzles 23.

As can be seen in FIGS. 2 and 3, the pressure tank 11 is preferably arranged at a location that is spaced apart from the spinning nozzles 1 (for example, on a carrier 16 or a frame element of the air spinning machine). Preferably, the pressure tank 11 is connected to a main supply line 17, from which several additive supply lines 14 allocated to the individual spinning units 15 in turn branch off. Thus, the air spinning machine includes a line system through which the individual spinning nozzles 1 may be supplied with additive 9, whereas the line system runs independent of the individual air supply lines 24, through which the air nozzles 23 of the spinning nozzles 1 are supplied with compressed air, and are typically in connection with a compressed air supply 18 of the air spinning machine. Thus, the pressure inside the pressure tank 11, more specifically described with reference to FIG. 4, may be regulated or adjusted independent of the pressure of the compressed air flowing through the air nozzles 23, such that the dosage of the additive 9 delivered through the additive deliveries 13 may be independently regulated.

As can also be seen in FIG. 3, each of the individual additive supply lines 14 may include a means 21 for adjusting the volume flow and/or mass flow of the additive 9 delivered through the additive deliveries 13, which is preferably formed by a valve that is adjustable manually or with the assistance of a controller.

In addition, a manual valve 22 is integrated into the main supply line 17 and/or in individual or all additive supply lines 14; this is manually operable and, with its assistance, individual sections of the specified line system may be shut off (for example, in order to service corresponding sections or associated assemblies of the air spinning machine).

FIG. 4 shows a possible arrangement or integration of the pressure tank 11. As this figure shows, the pressure tank 11 is filled with additive 9 along with a gaseous pressure medium 12, preferably compressed air, whereas the compressed air may originate from the compressed air supply 18 of the air spinning machine or a compressed air line connected to it. At its bottom area, the pressure tank 11 is in connection with the specified main supply line 17, through which the additive 9 is fed to the spinning units 15 or the additive supply lines 14.

In addition, the pressure tank 11 is in connection with an additive reservoir 19, from which additive 9 is led into the pressure tank 11 if the additive level falls below a threshold.

In order to enable automatic refilling of the pressure tank 11, a valve 10 may be integrated into the line 20 connecting the pressure tank 11 to the additive reservoir 19, which valve is automatically opened if the additive level falls below the specified threshold and is once again closed if an upper threshold is reached. For this purpose, the valve 10 is in operative connection with, for example, a sensor 33, which is designed to monitor the additive level. The sensor 33 may comprise, for example, a float gauge, which rises or falls with the level of the additive 9.

The additive reservoir 19 may also be in connection with a compressed air source through a corresponding line 32, in order to enable the transport of the additive 9 in the direction of the pressure tank 11. It is also conceivable to allocate a pump, which brings about the specified transport, to the additive reservoir 19 or the pressure tank 11.

Furthermore, the pressure tank 11 may feature a pressure sensor 34, with which the pressure of the gaseous pressure medium 12 prevailing in the pressure tank 11 is able to be measured or monitored. For its part, the pressure sensor 34 may be in operative connection with a pressure valve 35 (or a throttle valve) through (for example) a corresponding connector 36, which is preferably found in the line 32 of the air spinning machine connecting the pressure tank 11 and the compressed air supply 18. Through the interaction of the pressure sensor 34 and the pressure valve 35, the pressure inside the pressure tank 11 ultimately may be adjusted on the basis of the corresponding thresholds or guidelines.

Finally, a filter 38 is integrated into the line connecting the additive reservoir 19 and the pressure tank 11; with the assistance of the filter, impurities contained in the additive 9 may be filtered out. Of course, the filter 38 may also be a component of the additive reservoir 19 or of the pressure tank 11. It is also possible to integrate the filter 38 into the main supply line 17 and/or one or more of the additive supply lines 14.

The invention is not limited to the illustrated and described embodiments. Variations within the framework of the patent claims, such as any combination of the described characteristics, even if they are illustrated and described in different parts of the description or the claims or in different embodiments.

### LIST OF REFERENCE SIGNS

1 Spinning nozzle
2 Yarn
3 Fiber composite
4 Inlet of the spinning nozzle
5 Vortex chamber
6 Yarn formation element
7 Outlet of the spinning nozzle
8 Additive supply
9 Additive
10 Valve
11 Pressure tank
12 Gaseous pressure medium
13 Additive delivery
14 Additive supply line
15 Spinning unit
16 Carrier of the air spinning machine
17 Main supply line
18 Compressed air supply of the air spinning machine
19 Additive reservoir
20 Line connecting the pressure tank and the additive reservoir
21 Means for adjusting the volume flow and/or the mass flow of the additive delivered through the additive delivery
22 Manual valve
23 Air nozzle
24 Air supply line
25 Air distributor
26 Fiber guide element
27 Draw-off channel
28 Air outlet
29 Stretching unit roller
30 Draw-off roller
31 Spooling device
32 Line connecting the pressure tank and the compressed air supply
33 Sensor for monitoring the additive level of the pressure tank
34 Pressure sensor
35 Pressure valve
36 Connector
37 Stretching unit
38 Filter

1. Air spinning machine with at least one spinning unit (15) comprising at least one spinning nozzle (1),
whereas the spinning unit (15) serves the purpose of producing a yarn (2) from a fiber composite (3) fed from a spinning nozzle (1),
whereas the spinning nozzle (1) features an inlet (4) for the fiber composite (3),
an internal vortex chamber (5),
a yarn formation element (6) protruding into the vortex chamber (5), along with
an outlet (7) for the yarn (2) produced inside the vortex chamber (5), and
whereas the spinning nozzle (1) features multiple air nozzles (23) leading into the vortex chamber (5), which are in fluid connection with at least one air supply line (24), whereas, during the operation of the air spinning machine, compressed air provided by the air supply line (24) flows through the air nozzles (23) into the vortex chamber (5) in order to generate a vortex air flow in the vortex chamber (5),
characterized in that,
the air spinning machine features an additive supply (8), which is formed to provide the spinning unit (15) with an additive (9),
whereas the additive supply (8) comprises a pressure tank (11) in which the additive (9) is held for forwarding to the area of the spinning unit (15) and in which a gaseous pressure medium (12) is contained, and
whereas the additive supply (8) comprises at least one additive supply line (14) running independent of the air supply line (24), through which the pressure tank (11) is connected to an additive delivery (13), and through which the additive (9) of the spinning nozzle (1) is able to be fed independent of the compressed air introduced through the air supply line (24) into the vortex chamber (5).

2-15. (canceled)
